(19) United States
(12) Patent Application Publication
(10) Pub. No.: US 2023/0227155 A1
(43) Pub. Date: Jul. 20, 2023

(54) MULTIPLE VEHICLE SYSTEM

(71) Applicants: Hyundai Motor Company, Seoul (KR); Kia Corporation, Seoul (KR)

(72) Inventors: Ernestine Fu, Superior Township, MI (US); Grey Parker, West Bloomfield, MI (US); Prasanna Natarajan, Aldie, VA (US); Matt Korich, Superior Township, MI (US); Jacob Viau, Superior Township, MI (US); David Wilson, Superior Township, MI (US); John Suh, Palo Alto, CA (US); David Byron, Southfield, MI (US); Mark Lister, Superior Township, MI (US)

(21) Appl. No.: 17/566,811

(22) Filed: Dec. 31, 2021

(51) Int. Cl. B64C 37/02; B64G 1/16; B64G 1/42

(52) U.S. Cl. CPC B64C 37/02; B64G 1/16; B64G 1/425; B64D 2221/00

(57) ABSTRACT

A combination two vehicle system is provided that includes a land-based vehicle configured for traversal over ground and an aerial vehicle configured for travel through air, where the aerial vehicle is configured to detachably couple with the land-based vehicle. The aerial vehicle includes stabilizing legs to provide stability for take-off or landing. A method of operating the vehicle system includes steps of: providing the land-based and the aerial vehicle having the stabilizing legs, and aerially transporting the vehicle system including the land-based vehicle and the aerial vehicle, where the stabilizing legs provide stability for take-off or landing. In addition, the land-based vehicle may transport a removable cargo pod, which the aerial vehicle may independently retrieve from the land-based vehicle.

### BACKGROUND

In general, vehicles are relatively limited in their modes of movement. For example, aerial vehicles, such as airplanes and drones, are able to travel through the air from location to location, but are generally very limited or incapable of ground-based movement. Similarly, ground-based vehicles, such as automobiles, are generally limited to travel on roads or, on occasion, off road travel that is accessible via roads or ground-based travel.

It is often necessary to provide ground vehicular access to difficult to access locations. For example, remote regions of wilderness may lack access via roads. While a land-based vehicle may be desired at a particular location, it may be difficult or impossible to provide such a land-based vehicle to the location due to lack of ground access. Moreover, even if a ground location is accessible via roads or ground transport, it may be difficult or impossible to reach a desired location in a timely manner due remoteness of the location.

In other circumstances, it may be difficult for a ground vehicle to reach a desired destination due to a current situation on the ground. For example, a natural disaster such as a forest fire, or a weather condition such as freshly laid ice or snow, may limit ground access to the desired destination. Military conflicts or geopolitical incidents may also limit ground access to the desired destination.

### SUMMARY

In one aspect, we now provide a multiple vehicle system that comprises an aerial vehicle and a land-based vehicle. That is, the present systems are capable of flight (aerial travel) as well as robust ground travel, including with one or more passengers for both aerial and ground travel.

In certain preferred aspects, the vehicle systems are capable of substantially vertical lift-off and landing for aerial transport. In certain preferred aspects, a vehicle system does not comprise a fixed wing. In other aspects, a vehicle systems comprises one or more fixed wings. In other aspects, a vehicle systems comprises one or more rotary wings. In certain preferred systems, a vehicle comprises an aerial flight propulsion apparatus such as one or more rotating propellers or wings that are retractable or otherwise adjustably positioned to provide a reduced dimension (e.g. width or height) particularly when the vehicle is used for ground-based transport.

In certain preferred aspects, components of a multiple vehicle system are configured for cooperative transport, for example where the aerial vehicle component is configured to convey the land-based vehicle component during aerial travel for delivery to a desired location. In accordance with some embodiments, the aerial vehicle component and the land-based vehicle component are operable to provide cooperative or symbiotic operations.

In certain preferred aspects, the aerial vehicle component is capable of transporting the land-based vehicle component in flight, i.e. the aerial vehicle component has sufficient power and size to provide airborne transport to the combined aerial vehicle component and land-based vehicle component. This distinct from a ground vehicle that may contain an aerial adjunct (e.g. detaching drone) where the aerial adjunct is not capable and/or intended to provide reliable aerial lift-off and/or transport to the land-based vehicle.

in certain aspects, vehicle components of a multiple vehicle system are separable. For instance, an aerial vehicle component and a land-based (ground-based) vehicle component may be releasably attached or engaged. For example, the aerial vehicle component and ground-based component may have one or more mating engagement features that can provide releasable locking of the components such as by a latch or clamp system or other mechanism. Preferably, the aerial vehicle component and a land-based or ground-based vehicle component may be releasably attached or engaged during either aerial or ground-based travel, or during both aerial and ground-based travel.

In other aspects, the aerial vehicle component and a land-based vehicle component may be releasably attached or engaged only during air travel. Again, suitably the aerial vehicle component and land-based component may have one or more mating engagement features that can provide releasable locking of the components such as by a latch or clamp system or other mechanism. In such an embodiment, the vehicle components may be separated for ground or land transport and re-engaged for subsequent air travel.

In yet other aspects, the aerial vehicle component and a land-based or ground-based vehicle component may be releasably attached or engaged only during ground or land-based travel. Again, suitably the aerial vehicle component and land-based component may have one or more mating engagement features that can provide releasable locking of the components such as by a latch or clamp system or other mechanism. In this embodiment, the vehicle components may be separated for air travel and engaged for ground travel.

In certain preferred embodiments, the speed and efficiency of air travel for delivery of a land-based vehicle to a particular location can be utilized in combination with the ground-based movement of a land-based vehicle at the location. This can allow expeditious and targeted deployment of a land-based vehicle for land-based operation.

In certain preferred systems, power to provide drive and other operation of the vehicle components may be shared between the vehicle components. For instance, electric power (e.g., one or more batteries), hydrogen (one or more fuel cells), petroleum based power (combustion engine) may be housed within either or both the aerial vehicle component and the land—-based vehicle component and provide power to either or each of the vehicle components.

In certain preferred systems, data that may received or generated in one vehicle component may be communicated to the other vehicle component, for example through a wireless transmission and/or directly linked communication system. Such data sharing may occur with the vehicle components coupled as discussed above, of where the vehicle components are separated. The data may include sensory information regarding the environment surrounding the vehicle where such information is used for navigation.

The present vehicles may be suitably powered by any of a variety of systems include electric power, petroleum powered, hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In one implementation, the aerial vehicle is a hybrid electric/gas powered vehicle and the land-based vehicle is an electric powered vehicle. In some embodiments, the aerial vehicle operates as a mobile charging station for the land-based vehicle, providing charging capability via an electrical connection. It should be appreciated that the electrical connection for providing power can be wired connection or a wireless connection.

In another embodiment, the land-based vehicle component includes a cargo pod that can detach such as from the chassis of the land-based vehicle component. The cargo pod can be removed from the land-based vehicle and can be retrieved by the aerial vehicle. For example, if there is a ground-based operation in which the land-based vehicle is used for collection of goods or materials, the aerial vehicle can retrieve the cargo pod including the collected goods or materials and deliver the cargo pod to another destination while the land-based vehicle continues collection. In some examples, the land-based vehicle has more than one cargo pod or the aerial vehicle can delivery another cargo pod to the land-based vehicle, such that the ground operation can continue while the aerial vehicle transports the cargo pod to another destination.

In additional aspects, methods for operating the disclosed vehicle systems are provided. For instance, in one aspect, preferred methods include (a) providing a vehicle system that comprises a (i) a land-based vehicle component and (ii) an aerial vehicle component; and (b) aerially transporting the vehicle system that comprises the (i) land-based vehicle component and (ii) aerial vehicle component. Suitably, the (i) land-based component and (ii) aerial vehicle component are releasably engaged during the aerial transporting. Suitably, following the aerial_ transporting the vehicle system is operated as a ground vehicle. Suitably, the (i) land-based component and (ii) aerial vehicle component are releasably engaged during such ground vehicle locomotion. In other aspects, suitably the (i) land-based component and (ii) aerial vehicle component are disengaged during the ground vehicle locomotion.

In certain aspects, preferably, during ground-based use, the vehicle system or separated land-based vehicle component can provide established road—-based usage, such as operating at speeds of at least 20, 30, 40, 50 60 miles per hour or greater for at least 10, 20, 30, 40, 50, 60, 120 or 180 minutes or more.

In certain aspects, during ground-based use, the vehicle system or separated land-based vehicle component will utilize at least four rolling tires.

The present vehicle systems and land-based vehicle and aerial vehicle components thereof suitably may be configured to each transport 1, 2, 3, 4, 5 or 6 more passengers. In alternative configurations, one or more passengers may be positioned during travel in the land-based vehicle component and no passengers in the aerial vehicle component. In other configurations, one or more passengers may be positioned during travel in the aerial land-based component and no passengers in the land-based vehicle component.

The size of a present vehicle component suitably may vary widely. In certain aspects the maximum width of a vehicle system or land-based vehicle component will be about 120 inches or less, or 102 inches or less, or 96 inches or less, for example to comply with road-use regulations in certain countries. In certain aspects the maximum height (measured from ground surface contacting e.g. tire of vehicle to highest point of vehicle) of a vehicle system and or land-based vehicle component will be about 20, 19, 18, 17, 15, 15, 14, 13.5, 13, 12, 11, 10, 9, 8, 7, 6, or 5 feet or less, for example to comply with road—-use regulations in certain countries. In certain aspects the maximum length of a vehicle system and or land-based vehicle component will be about 80, 75, 70, 60, 50, 40, 30, 20, 10, 8, 7 or 6 feet or less.

Additional aspects of the invention are disclosed infra.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 depicts a combination two vehicle system including an aerial vehicle and a land-based vehicle, according to some embodiments.

FIG. 2 depicts an aerial vehicle of the combination two vehicle system, according to some embodiments.

FIG. 3 depicts a land-based vehicle of the combination two vehicle system, according to some embodiments.

FIG. 4 depicts an example of a latching mechanism of a combination two vehicle system for docking a land-based vehicle to an aerial vehicle, according to some embodiments.

FIG. 5 depicts a combination two vehicle system including an aerial vehicle conveying a land-based vehicle to a destination, in accordance with an embodiment.

FIG. 6 depicts a land-based vehicle serving as a mobile charging station, in accordance with an embodiment.

FIG. 7 depicts a combination two vehicle system including a land-based vehicle having a cargo pod, in accordance with an embodiment.

FIG. 8 depicts a combination two vehicle system including an aerial vehicle surveying terrain and communicating information about the terrain to a land-based vehicle, in accordance with an embodiment.

FIG. 9 depicts a combination two vehicle system including an aerial vehicle and a land-based vehicle operating in combination to provide long-distance communication, in accordance with an embodiment.

### DETAILED DESCRIPTION

As discussed, we now provide a multiple vehicle system that comprises an aerial vehicle and a land-based vehicle. That is, the present systems are capable of flight (aerial travel) as well as robust ground travel. Preferred vehicle systems include a combination two vehicle system including an aerial vehicle and a land-based vehicle. In certain preferred aspects, the constituent vehicles of the combination two vehicle system are configured for cooperative transport, such that the aerial vehicle is configured to convey the land-based vehicle during aerial travel for delivery to a desired location. In accordance with some embodiments, the aerial vehicle and the land-based vehicle are operable to provide cooperative or symbiotic operations.

The terms “aerial vehicle” and “aerial vehicle component” are generally used interchangeably herein. The terms “land-based vehicle” and “land-based vehicle component” also are generally used interchangeably herein.

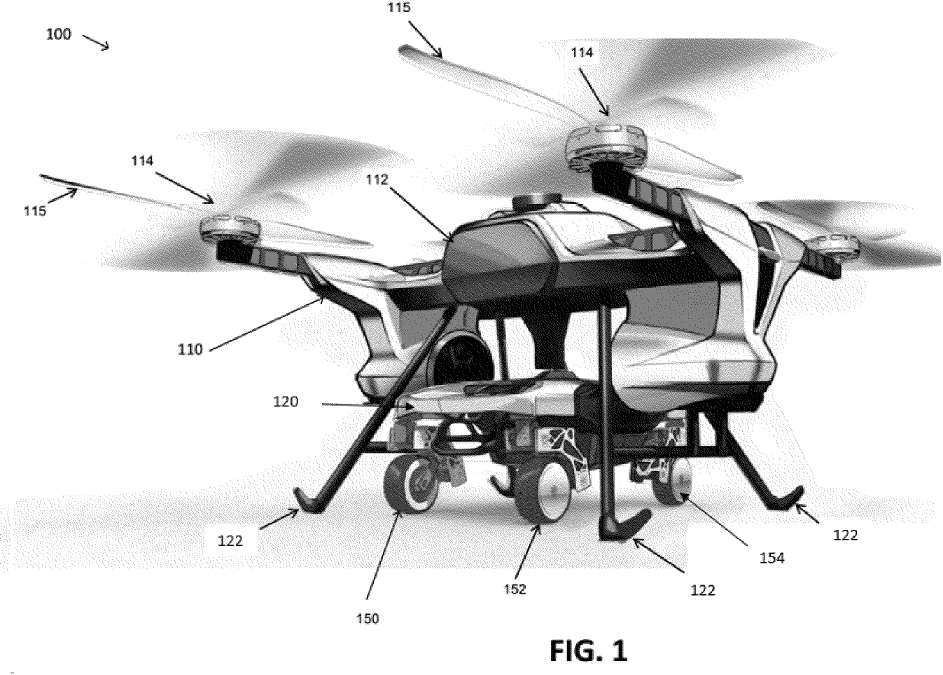

Referring now to the drawings, FIG. 1 depicts a multiple vehicle system 100 including an aerial vehicle 110 and a land-based vehicle 120, according to some embodiments. Aerial vehicle 110 is configured to removably couple to land-based vehicle 120 for conveyance of land-based vehicle 120 from a first location to a second location for land-based operation. Multiple (two) vehicle system 100 leverages the speed and efficiency of air travel with the value of land-based operations using land-based vehicle 120.

In some embodiments, aerial vehicle 110 is able to convey land-based vehicle 120 to an otherwise inaccessible or difficult to access location, either due to limits on ground access or travel time. For example, the destination may be located in a remote region without access by roads, or the destination may be far enough away such that ground access would not be possible for timely conveyance of land-based vehicle 120. In other examples, the destination may be difficult to access on the ground due to current conditions, such as natural disasters, weather conditions, military conflict zones, or other forms of civil unrest. Combination two vehicle system 100 is capable of delivering land-based vehicle 120 for ground operations using aerial vehicle 110.

It should be appreciated that various design considerations and optimizations are taken into account when designing combination two vehicle system 100 based on potential use cases. For example, since aerial vehicle 110 is configured to convey a land-based vehicle 120 through the air to a destination, and potentially to convey additional cargo of land-based vehicle 120 and/or aerial vehicle 110 such as in cargo unit 112, land-based vehicle 120 should be as preferably light weight and strong.

As shown in FIG. 1, aerial vehicle 110 suitably has one or as depicted a plurality of rotary wings units 114 with blades 115. Such a configuration can provide for vertical aerial takeoffs and landings as discussed. The vehicle 100 may further optionally include one or more grounding or stabilizing legs 122 that can aid landings and takeoffs and provide further integrity to the combined vehicle 100. During aerial or land-based travel of vehicle 100, legs 122 can be retracted or otherwise withdrawn or removed as desired.

As further shown in FIG. 1, the vehicle 100 includes one or more tires 150, 152, 154 for ground-based travel. The vehicle 100 suitably comprises four or more tires.

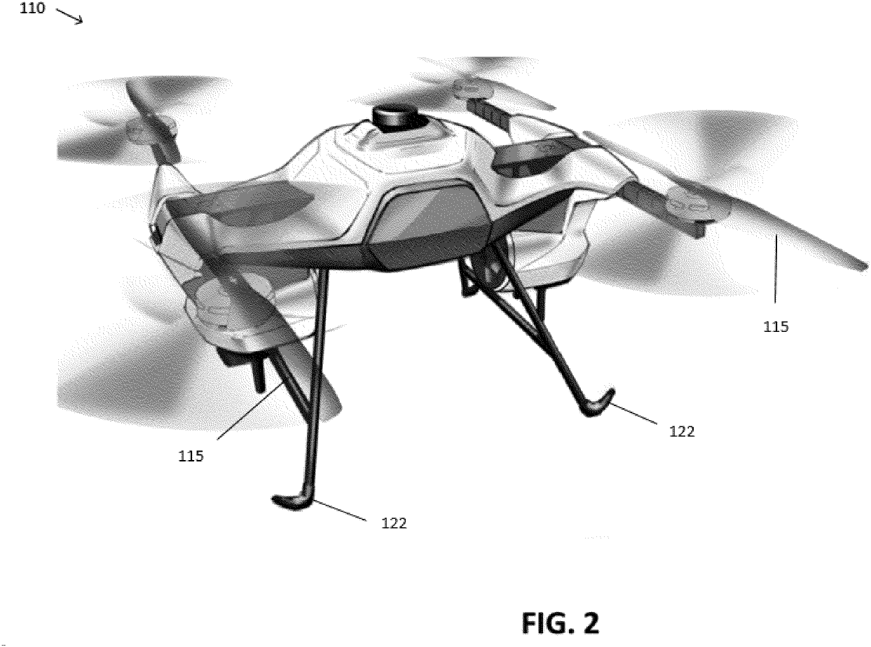

FIG. 2 shows aerial vehicle 110 of the combination two vehicle system 100 separated from an associated land-based vehicle. The depicted aerial vehicle 110 suitably may be a drone or any type of airborne vehicle capable of air travel, including without limitation: an airplane, a helicopter, a hovercraft, or other self-propelling airborne vehicles. The depicted aerial vehicle include rotary wings 115 and stabilizers 122.

In accordance with various embodiments, aerial vehicle 110 is capable of remote operation, autonomous operation, or a combination of remote and autonomous operation. For example, a user may be able to remotely control operation of aerial vehicle 110, such as from a command center. In other examples, aerial vehicle 110 is configured to operate autonomously, such that a destination is provided and aerial vehicle 110 is capable of self-navigating to the destination.

In some embodiments, aerial vehicle 110 is powered using hybrid power including a combination of combustion and electrical power sources. In such embodiments, the combustion component of the hybrid power source can charge a battery of the electrical power source during operation. The hybrid power source can also be used as a charging station for land-based vehicle 120, either during air travel or on the ground, when land-based vehicle 120 is coupled to aerial vehicle 110.

Aerial vehicle 110 is capable of performing short takeoffs and landings. In some embodiments, aerial vehicle 110 is capable of performing substantially vertical takeoffs and landings, but this may be difficult in certain situation, e.g., where aerial vehicle 110 is carrying land-based vehicle 120 and/or another heavy payload. In some embodiments, aerial vehicle 110 is capable of hovering at a substantially steady position during operation (e.g., is a drone).

Aerial vehicle 110 includes a connection mechanism for detachably coupling to land-based vehicle 120. In some embodiments, aerial vehicle 110 is configured to engage the connection mechanism with land-based vehicle 120 by approaching land-based vehicle 120 vertically or laterally from one direction.

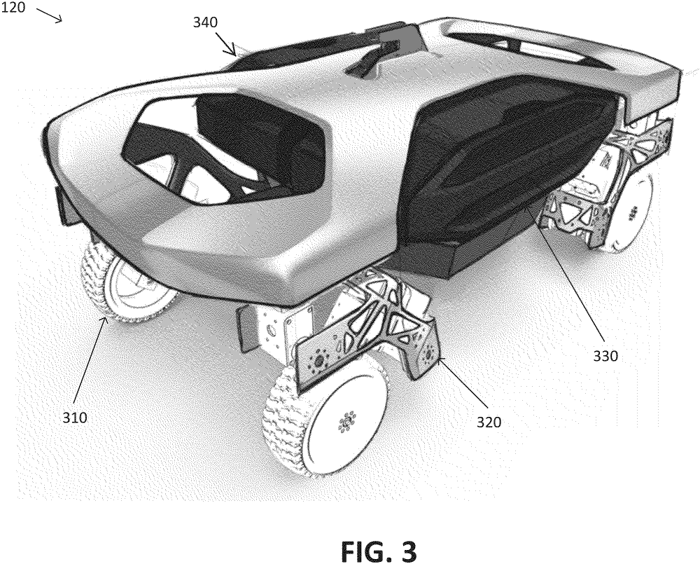

FIG. 3 is a diagram illustrating a land-based vehicle 120 of the combination two vehicle system 100, according to some embodiments. As illustrated, land-based vehicle 120 is capable of wheel-based travel using wheels 310 and walking travel using nesting leg units 320. Preferred nesting leg units 320 are described in U.S. Pat. Application Publication No. 2020/0216127. While land-based vehicle 120 is illustrated as having wheels 310 and nesting leg units 320, it should be appreciated that land-based vehicle 120 may be any type of vehicle capable of ground travel, including without limitation: an automobile, a continuous track vehicle, etc.

In certain aspects, land-based vehicle 120 is capable of navigating extreme and rugged terrain that is typically unnavigable for conventional automobiles or off-road vehicles. For example, nesting leg units 320 are capable of providing walking travel for land-based vehicle 120 as disclosed in U.S. Pat. Application Publication No. 2020/02161271. In designing land-based vehicle 120, and nesting leg units 320 (or any other mechanism for providing walking travel), four metrics of motion capabilities should be considered:
the height of any step onto which land-based vehicle 120 might need to climb;
the steepness of any angle which land-based vehicle 120 might need to traverse;
the height and width (e.g., depth) of an obstacle over which land-based vehicle 120 might need to traverse; and
the width (e.g., depth) of any gap which land-based vehicle 120 might need to step over.
As should be understood, these exemplary metrics are considerations for designing the ground traversal abilities of land-based vehicle 120, and might be dependent or based on potential locations for usage of land-based vehicle 120. For example, these four metrics would be different for different climates and terrains, as well as urban or wilderness terrains.

Various other factors should also be considered in designing land-based vehicle 120. For example, as land-based vehicle 120 is designed for use in different extreme environments, land-based vehicle 120 should be designed to withstand environments of both hot and cold temperatures, should be able to withstand rain and water damage, and be able to traverse different types of ground (e.g., sand, snow, ice, brush, water, etc.) In some embodiments, land-based vehicle 120 may be used on the surface of the moon or other planets, such as Mars, and should be designed according to those environments.

In accordance with various embodiments, land-based vehicle 120 is capable of remote operation, autonomous operation, or a combination of remote and autonomous operation. For example, a user may be able to remotely control operation of land-based vehicle 120, such as from a command center. In other examples, land-based vehicle 120 is configured to operate autonomously, such that a destination is provided and land-based vehicle 120 is capable of self-navigating to the destination.

In some embodiments, land-based vehicle 120 includes cargo pod 330 as shown in FIG. 3 that can detach from the chassis of land-based vehicle 120. Cargo pod 330 can be removed from land-based vehicle 120 and can be retrieved by the aerial vehicle.

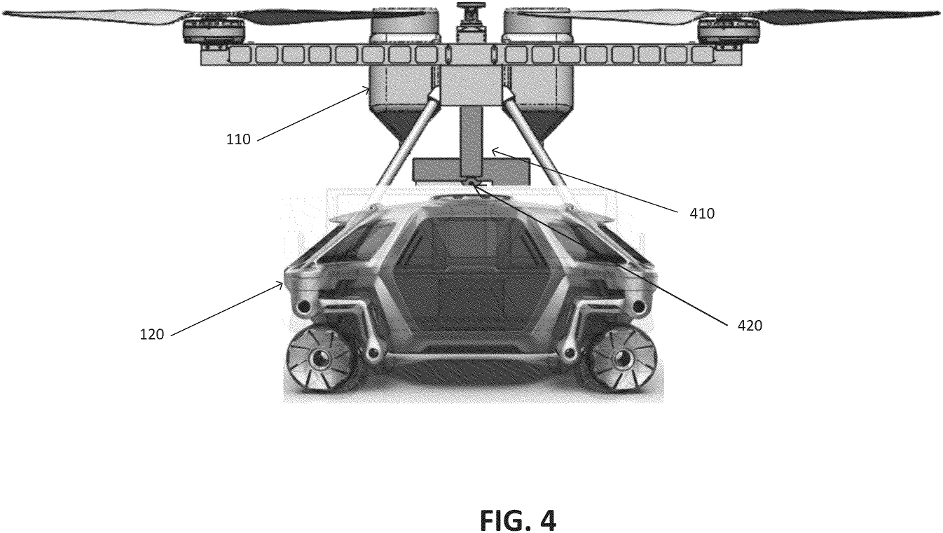

FIG. 4 is a diagram illustrating an example connection mechanism 410 of a combination two vehicle system 100 for docking a land-based vehicle 120 to an aerial vehicle 110, according to some embodiments. Aerial vehicle 110 includes a connection mechanism 410 for detachably coupling to land-based vehicle 120. In some embodiments, aerial vehicle 110 is configured to engage connection mechanism 410 with land-based vehicle 120 by approaching land-based vehicle 120 vertically or laterally from one direction. For example, aerial vehicle 110 can vertically approach land-based vehicle 120 such that connection mechanism 410 engages with a bolt or pin of land-based vehicle 120. This example is useful in vertical takeoffs and landings. In another example, aerial vehicle 110 can laterally approach land-based vehicle 120 (e.g., parallel to the ground) such that connection mechanism 410 engages with a bolt or pin of land-based vehicle 120. This example is useful in short takeoffs and landings. It should be appreciated that various different types of connection mechanisms are contemplated and may be used in accordance with the described embodiments.

In some embodiments, aerial vehicle 110 includes a hoist and cable for lowering and raising connection mechanism 410. For example, deployment or recovery of land-based vehicle 120 may be in a location where aerial vehicle 110 is unable to land (e.g., dense trees or heavy winds). Aerial vehicle 110 can hover over the destination and deploy or recover land-based vehicle by lowering and raising connection mechanism 410 using the hoist and cable. Connection mechanism 410 can be released (for deployment) or engaged (for retrieval) when land-based vehicle 120 is on the ground. Another example of a use for hoist and cable deployment and retrieval is into a cave or pit that is inaccessible by ground travel.

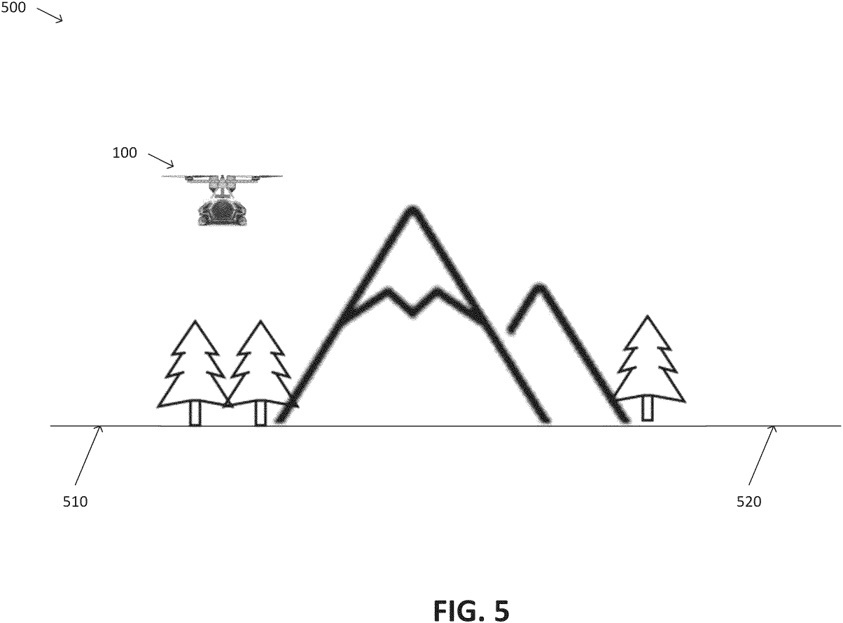

FIG. 5 is a diagram illustrating a use case of a combination two vehicle system 100 including aerial vehicle 110 conveying land-based vehicle 120 to a destination, in accordance with an embodiment. Aerial vehicle 110 is configured to removably couple to land-based vehicle 120 for conveyance of land-based vehicle 120 from a first location 510 to a second location 520 for land-based operation. Second location 520 is inaccessible via ground access from first location 510. Second location 520 is a destination at which ground operations are to be performed by land-based vehicle 120.

As illustrated, second location 520 is inaccessible via ground access from first location 510 due to the extreme terrain (e.g., mountains and forest) between first location 510 and second location 520. It should be appreciated that second location 520 may be inaccessible via ground access from first location 510 for other reasons, such as distance (e.g., travel time is too long for ground access), weather conditions, natural disasters (e.g., forest fires, floods, earthquakes), military conflict, or other forms of civil unrest.

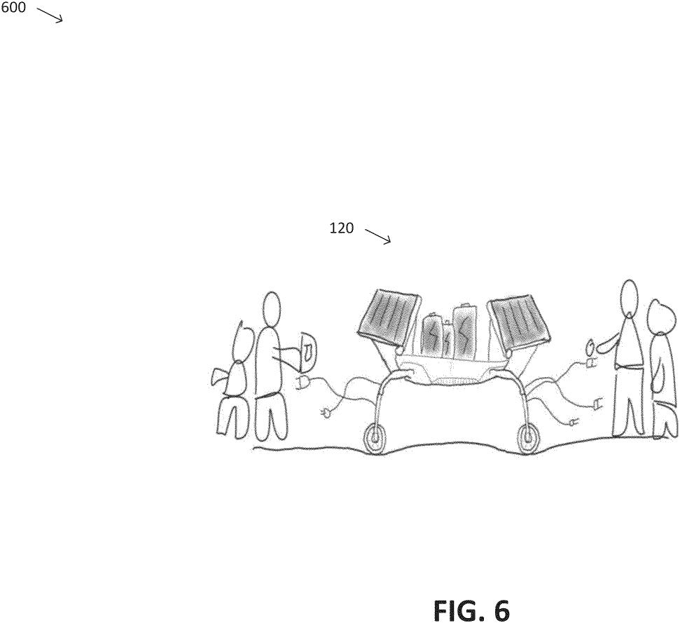

It should be appreciated that various types of ground operations can be performed by land-based vehicle 120. For instance, FIG. 6 is a diagram illustrating a use case of a land-based vehicle 120 acting as a mobile charging station, in accordance with an embodiment. A mobile charging station is configured to provide mobile power to resources located at a destination. For instance, a remote location that is inaccessible or difficult to access over land requires a source of power, such as a natural disaster rescue staging site, a refugee camp, a military camp, etc. Aerial vehicle 110 can convey land-based vehicle 120 to the destination, where land-based vehicle 120 is configured to provide power on-demand to devices at the destination.

In some embodiments, land-based vehicle 120 includes a battery for storing and providing power to connected devices. In one embodiment, aerial vehicle 110 is configured to charge the battery of land-based vehicle 120 (e.g., during air travel). In some embodiments, land-based vehicle 120 includes solar panels for charging the battery.

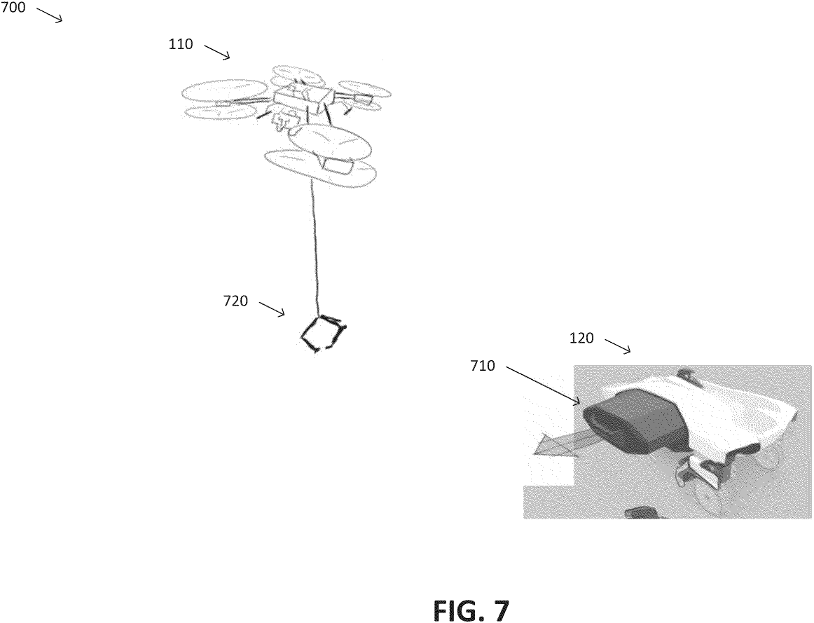

FIG. 7 is a diagram illustrating a use case 700 of a combination two vehicle system 100 including a land-based vehicle 120 having a cargo pod 710, in accordance with an embodiment. Certain ground-based operations in which land-based vehicle 120 is used may be for collection of goods or materials. Goods or materials may be loaded into cargo pod 710, which may be removable from land-based vehicle 120. Land-based vehicle 120 may transport the cargo pod 710 including the goods or materials.

In some embodiments, aerial vehicle 110 can retrieve cargo pod 710 (e.g., using a connection mechanism 720) including the collected goods or materials and deliver cargo pod 710 to another destination while land-based vehicle 120 continues collection. In some examples, land-based vehicle 120 has more than one cargo pod 710 or aerial vehicle 110 can delivery another cargo pod 710 to land-based vehicle 120, such that the ground operation can continue while aerial vehicle 110 transports the first cargo pod 710 to another destination.

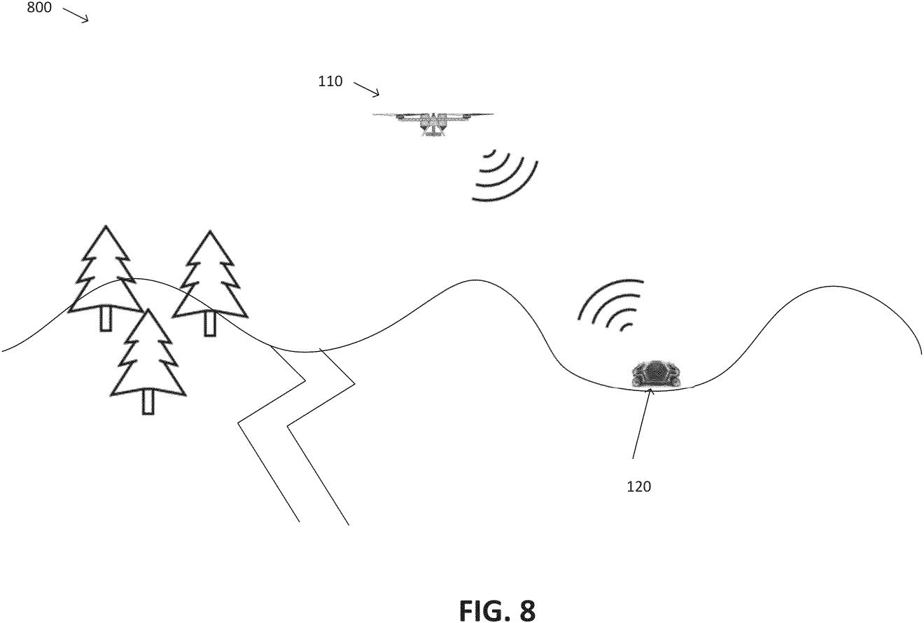

FIG. 8 is a diagram illustrating a use case 800 of a combination two vehicle system 100 including aerial vehicle 110 surveying terrain and communicating information about the terrain to land-based vehicle 120, in accordance with an embodiment. Land-based vehicle 120 may be performing ground operations, for example, under autonomous control, and have incomplete information as to the terrain that must be traveled over. For example, conditions on the ground may not be known due to changes to the environment (e.g., natural disasters) or weather (e.g., flooding).

In such use cases, aerial vehicle 110 can scan the terrain and perform mapping of areas of interest (e.g., areas of travel by land-based vehicle 120). Aerial vehicle 110 can transmit the information about the terrain, such as mapping information, to land-based vehicle 120. Land-based vehicle 120 may then use this information in addition to any information it has or is capable of obtaining on its own, to supplement the navigation of land-based vehicle 120 over the terrain. This symbiotic use case of aerial vehicle 110 supplementing the navigation information of land-based vehicle 120 is particularly useful in extreme environments where the terrain may be unknown. For example, this may be particularly useful in exploration of the moon or other planets.

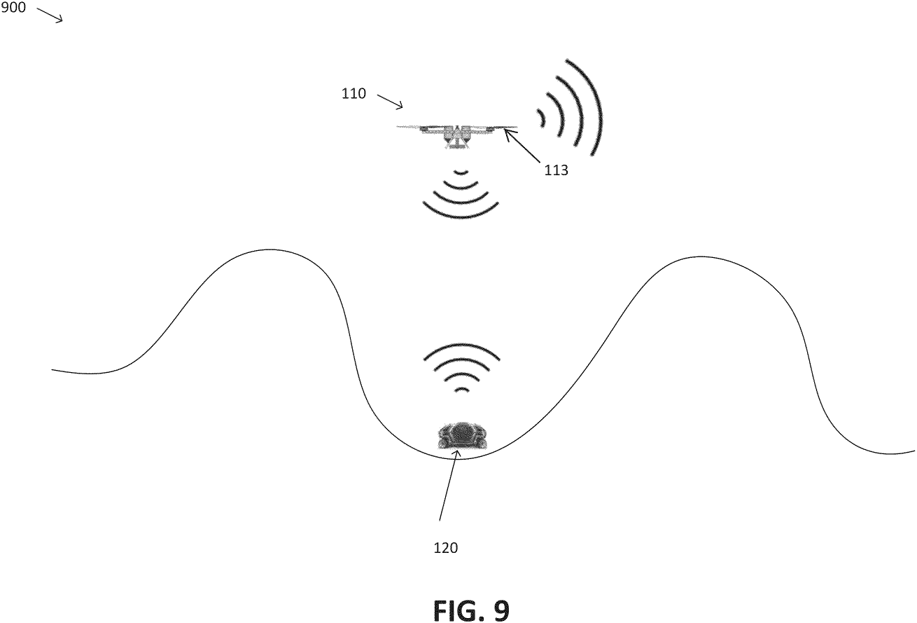

FIG. 9 is a diagram illustrating a use case 900 of a combination two vehicle system 100 including aerial vehicle 110 and land-based vehicle 120 operating in combination to provide long-distance communication, in accordance with an embodiment. Land-based vehicle 120 may be performing ground operations requiring data communication to a remote location (e.g., a remote command post). Due to the terrain, it may be difficult for land-based vehicle 120 to maintain a consistent data link between the remote location. For example, land-based vehicle 120 may traverse a deep canyon with high walls, or otherwise lose a data connection due to natural features between land-based vehicle 120 and the remote command post.

In such use cases, aerial vehicle 110 can hover or fly over land-based vehicle 120 and act as an intermediary device for supporting data communications between land-based vehicle 120 and the remote command post. Aerial vehicle 110 can maintain a location in the air over land-based vehicle 120 above the natural features that might be blocking or disrupting data communication between land-based vehicle 120 and the remote command post, thereby improving the data connection between land-based vehicle 120 and the remote command post. This symbiotic use case of aerial vehicle 110 supplementing the data communication capabilities of land-based vehicle 120 is particularly useful in rugged terrain.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

1. A vehicle system comprising:
a land-based vehicle component; and
an aerial vehicle component having a plurality of stabilizing legs,
wherein the land-based vehicle and aerial vehicle components are releasably coupled, and
wherein the stabilizing legs are configured to provide stability for take-off or landing.

2. The vehicle system of claim 1 wherein the land-based vehicle component and aerial vehicle component are coupled by multiple engagements.

3. The vehicle system of claim 1 wherein the aerial vehicle component comprises a connection mechanism for detachable coupling with the land-based vehicle component.

4. The vehicle system of claim 1 wherein the land-based vehicle component and the aerial vehicle component are coupled via a data communication connection.

5. The vehicle system of claim 1, wherein the land-based vehicle and the aerial vehicle are coupled via an electrical connection.

6. The vehicle system of claim 5, wherein the electrical connection is configured to provide a power transmission between the land-based vehicle component and the aerial vehicle component, wherein the power transmission is configured to charge a battery of the land-based vehicle component.

7. The vehicle system of claim 1, wherein the land-based vehicle component comprises a removable cargo pod.

8. The vehicle system of claim 7, wherein the aerial vehicle component is configured to travel with the removable cargo pod independent of the land-based vehicle.

9. The vehicle system of claim 8 wherein the aerial vehicle component comprises a unit to retrieve the removable cargo pod from the land-based vehicle.

10. The vehicle system of claim 1 wherein the aerial vehicle component comprises a fixed wing.

11. The vehicle system of claim 1 wherein the aerial vehicle component comprises a rotary wing.

12. A vehicle system comprising:
a land-based vehicle component; and
an aerial vehicle component having a plurality of stabilizing legs,
wherein the land-based vehicle and aerial vehicle components are configured to be operated in combination or separately, and
wherein the stabilizing legs are configured to provide stability for take-off or landing.

13. A method of operating a vehicle system comprising,
(a) providing a vehicle system that comprises (i) a land-based vehicle component and (ii) an aerial vehicle component having a plurality of stabilizing legs; and
(b) aerially transporting the vehicle system that comprises the (i) land-based vehicle component and (ii) aerial vehicle component,
wherein the stabilizing legs are configured to provide stability for take-off or landing.

14. The method of claim 13 wherein the (i) land-based component and (ii) aerial vehicle component are releasably engaged during the aerial transporting.

15. The method of claim 13 wherein following the aerial transporting the vehicle system is operated as a ground vehicle.

16. The method of claim 15 wherein the (i) land-based component and (ii) aerial vehicle component are releasably engaged during the ground vehicle operation.

17. The method of claim 15 wherein the (i) land-based component and (ii) aerial vehicle component are disengaged during the ground vehicle operation.
